(19) United States
(12) Patent Application Publication
(10) Pub. No.: US 2026/0075059 A1
(43) Pub. Date: Mar. 12, 2026

(54) NETWORK DEVICE, CONTROL METHOD FOR NETWORK DEVICE, AND RECORDING MEDIUM

(71) Applicant: CANON KABUSHIKI KAISHA, Tokyo (JP)

(72) Inventor: YU MORIYASU, Tokyo (JP)

(21) Appl. No.: 19/309,761

(22) Filed: Aug. 26, 2025

(30) Foreign Application Priority Data
Sep. 6, 2024 (JP) 2024-154349

(51) Int. Cl. H04L 9/40

(52) U.S. Cl. CPC H04L 63/102; H04L 63/20

(57) ABSTRACT

An image forming apparatus that is available through login by a plurality of users having different authorities, and that includes a web server, wherein the web server provides a website for installing, in a user terminal, software as a Progressive Web App (PWA) for providing at least part of the functions of the image forming apparatus 102, and the web server provides a website such that a Progressive Web App (PWA) in which available functions differ according to an authority of a user who has logged in to the website can be provided.

### BACKGROUND

### Field of the Technology

The present disclosure relates to a network device, a control method for a network device, and a storage medium.

### Description of the Related Art

An image forming apparatus provides, to a client terminal that accesses the image forming apparatus via a network, a remote user interface (RUI) function that enables confirming the operating status of the image forming apparatus, operating jobs, and performing various settings and the like. The image forming apparatus is provided with a web server internally, and referencing information in the image forming apparatus and changing settings of the image forming apparatus becomes possible by a client terminal accessing the URL of the RUI by using a web browser or the like. In this context, there is a technology called a Progressive Web App (PWA). A PWA is a technology that enables a website to be used as if the website were a native app. There is no need for a user to install by downloading an application from an application store similar to conventional native apps, and in a case in which a website supports PWA, the website can be used by simple installation via a web browser. After installing a PWA, an icon is generated on the desktop or home screen and the like of the terminal similarly to a native app. The RUI of an image forming apparatus can be provided as a PWA by combining RUI technology and PWA technology.

Among information and settings of an image forming apparatus, there is information that only an administrator of the image forming apparatus can know and settings that only an administrator of the image forming apparatus can change. Japanese Patent Application Laid-Open No. 2020-205086 discloses an image forming apparatus that specifies authority of a user, and changes the display content of a screen for instructing the installation of an application to the image forming apparatus, in accordance with the authority of the user.

A general user who only uses functions of an image forming apparatus must not be able, by using the RUI of the image forming apparatus provided as a PWA, to know information that only an administrator of the image forming apparatus can know, nor to change settings that only the administrator can change. Accordingly, there is a need to provide a PWA after determining provision functions of the PWA that an image forming apparatus that is a network device provides in accordance with authority of a user.

### SUMMARY

An object of the present technology is to enable a network device to provide a PWA in accordance with authority of a user.

A network device of the present disclosure that is available through login by a plurality of users having different authorities and that includes a web server comprising: a memory storing instructions; and a processor executing the instructions causing the network device to: provide a website for installing software as a Progressive Web App (PWA) for providing at least part of the functions of the network device to a user terminal via the web server, wherein the web server provides the website such that a Progressive Web App (PWA) having different available functions can be provided according to authority of a user who has logged into the website.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram showing a configuration of a management system.

FIG. 2 is a diagram showing a hardware configuration of an image forming apparatus 102 that is a network device.

FIG. 3 is a diagram showing a hardware configuration of a user terminal 103 that is a client apparatus.

FIG. 4 is a diagram showing a software configuration of an image forming apparatus 102 that is a network device.

FIG. 5 is a diagram showing a software configuration of a user terminal 103 that is a client apparatus.

FIG. 6 is a sequence diagram explaining PWA installation processing executed in the management system.

FIG. 7 is a diagram showing an example of a login screen for the RUI displayed in a browser 505.

FIG. 8 is a diagram showing an example of a PWA screen for a general user having authority different from administrator authority.

FIG. 9 is a diagram showing an example of a PWA screen for an administrative user having administrator authority.

FIG. 10 is a diagram showing an example of a standard RUI that an image forming apparatus 102 provides.

FIG. 11 is a flowchart showing login processing that a PWA performs.

FIG. 12A and FIG. 12B are diagrams showing an example of a login screen displayed in login processing for a PWA.

### DESCRIPTION OF THE EMBODIMENTS

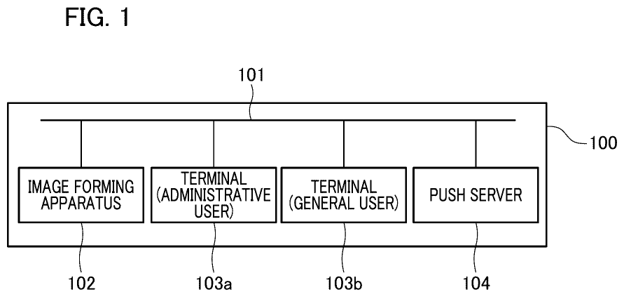

FIG. 1 is a diagram showing an overall configuration of a management system. The management system is a system for managing network devices. The management system includes a network device to be managed and a client apparatus capable of communicating with the network device. A management system 100 according to the present embodiment includes an image forming apparatus 102 that is a network device and a user terminal 103 (a user terminal 103a and a user terminal 103b) that is a client apparatus. In addition, the management system may include a server that provides various services related to network devices, and the management system 100 of the present embodiment includes a push server 104.

The image forming apparatus 102, the user terminal 103, and the push server 104 are connected so as to be capable of communicating with each other via a network 101. The network 101 is a so-called communication network that is realized by, for example, a LAN, a WAN, a telephone line, a dedicated digital line, an ATM or frame relay line, a cable television line, a wireless line for data broadcasting, and the like. It should be noted that the push server 104 may be constructed on an intranet environment in which the image forming apparatus 102 and the user terminal 103 are used, or the push server 104 may be connected via the Internet to the intranet environment in which the image forming apparatus 102 and the user terminal 103 are used.

The image forming apparatus 102 is an example of a network device that includes a web server and can be used by a plurality of users having different authorities when logging in. The network device provides a function by which confirmation of operating status of the network device, job operations, setting of various items, and the like can be performed to a client apparatus that accesses the network device via a network. This function is a function that provides at least a part of functions of the network device, and this function is called a remote user interface (hereinafter, referred to as RUI or remote UI). That is, the image forming apparatus 102 provides the RUI to the user terminal 103. The URL of the RUI can be accessed by using a web browser and the like of the user terminal 103. Screens, functions, setting items, and the like that the image forming apparatus 102 provides in the RUI differ according to authority of a user. Authority of a user of the image forming apparatus 102 includes administrator authority and authority different from administrator authority (authority that does not have administrator authority).

A mechanism for providing information of network devices via a network by the management system is realized by using a Progressive Web App (hereinafter, referred to as PWA) in addition to the RUI of a website. That is, the RUI that the image forming apparatus 102 provides can be realized by using a PWA. A PWA is a technology that enables use of a web application related to a website as if the web application were an application operating on a client apparatus. A PWA is application software that is constructed by using general web technologies such as HTML, CSS, JavaScript, WebAssembly, and the like, and that can be downloaded and installed via a web browser.

A PWA does not need to be downloaded by a user from an application store that is deployed by a vendor that provides an operating system (OS), for example, and installed on a client apparatus. For example, a user can use a PWA by accessing a PWA-compatible website using a web browser of a client apparatus and downloading the PWA. Content of a PWA can also be freely designed by the provider of the website.

A network device is provided with a web server that provides the RUI and a website that can provide a PWA having RUI functions. Software as a PWA for providing at least a part of functions of the network device is created by the web server, and a website for installing the created PWA to the user terminal 103 via the network is provided. The image forming apparatus 102 that is a network device is, for example, a multifunction printer (MFP) in which a plurality of functions such as a printing function, a reading function, a FAX function, and the like are integrated. It should be noted that the network device may be a device that is provided with a web server and can provide the RUI and a PWA, such as a printer, a scanner apparatus, a 3D printer, an information processing apparatus such as a PC, an image processing apparatus such as a camera, digital medical equipment, smart home appliances, and the like.

The user terminal 103 is an example of a client apparatus. The user terminal 103 is, for example, a client apparatus such as a personal computer (PC) and the like that a user uses for business and the like. The client apparatus may be a smartphone, a tablet terminal, and the like in addition to a PC. In the present embodiment, the user terminal 103a is a terminal that a user having authority of an administrator of the image forming apparatus 102 (hereinafter, referred to as an administrative user) uses. In contrast, the user terminal 103b is a terminal that a user who does not have administrator authority of the image forming apparatus 102, that is, a user having authority different from administrator authority (hereinafter, referred to as a general user) uses.

The push server 104 provides push services. The push server 104 is prepared by vendors of web browsers and OSes for providing push services. In a PWA, push notifications to a client apparatus from a web server that providers of websites and the like construct, display of icons on a home screen, and the like also become realizable by utilizing functions of Service Worker. Push notification is realized via the push server 104, and in that case, a predetermined API that an OS or web browser of a client apparatus supports is used. The push server 104 mediates communication between the image forming apparatus 102 and the user terminal 103 for the purpose of realizing push notification from the web server of the image forming apparatus 102 to a client apparatus using a PWA. The push server 104 is constructed by using, for example, a server computer that communicates with the image forming apparatus 102 and the user terminal 103. Alternatively, the push server 104 can also be constructed by adopting cloud computing technology and the like.

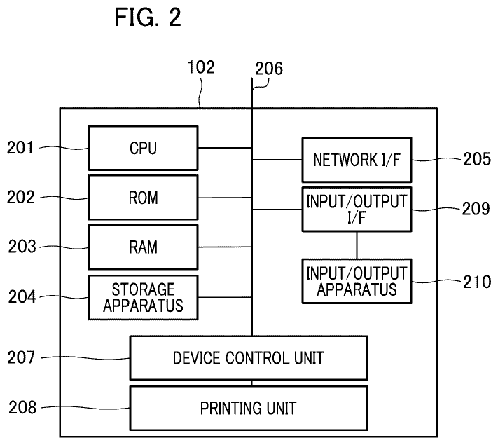

FIG. 2 is a diagram showing a hardware configuration of an image forming apparatus 102 that is a network device. The image forming apparatus 102 includes a CPU 201, a ROM 202, a RAM 203, a storage apparatus 204, a network I/F 205, a device control unit 207, an input/output I/F 209, and an input/output apparatus 210. Each of these units is connected via an internal bus 206. Furthermore, the image forming apparatus 102 includes an input/output apparatus 210 that connects to the input/output I/F 209 and a printing unit 208 that connects to the device control unit 207.

A CPU (Central Processing Unit) 201 controls the image forming apparatus 102. The CPU 201 loads programs stored in memory (ROM 202 or storage apparatus 204) to the RAM 203 as necessary and executes the programs, and comprehensively controls each unit connected to the internal bus 206. The ROM (Read Only Memory) 202 stores various programs such as basic control programs of the image forming apparatus 102 and the like. The RAM 203 (Random Access Memory) functions as memory or a work area of the CPU 201. For example, the RAM 203 stores device information of the user terminal 103, user information, event information generated in the image forming apparatus 102, various counter information, consumption information of consumable parts, various logs, and the like.

The storage apparatus 204 stores management information necessary for management of the image forming apparatus 102. Specifically, the storage apparatus 204 stores, for example, device configuration information such as firmware information and identification numbers of the image forming apparatus 102, various counter information, consumption information of consumable parts, operation history of the image forming apparatus 102, and history information (log data) that represents various abnormal states, and the like. In addition, the storage apparatus 204 also stores image data, device information of the user terminal 103 that performs communication with the image forming apparatus 102, user information, application programs, and the like. Furthermore, the storage apparatus 204 stores web server programs necessary for providing a PWA in addition to the RUI, data such as HTML and scripts, and information of related settings, and the like. The CPU 201 performs execution processing of programs together with the ROM 202 and the RAM 203, and performs processing of recording image data on recording media such as the storage apparatus 204, and the like.

The network I/F 205 exchanges data unidirectionally or bidirectionally via the network 101 with external network equipment or personal computers (PCs). An input/output apparatus 210 receives input and operations from users as an input unit. The input/output apparatus 210 may have hardware keys such as button boards, and the like. In addition, the input/output apparatus 210 is provided with a display as an output unit, and displays various information to users. It should be noted that the input/output apparatus 210 may be configured as a touch panel. By associating input coordinates and display coordinates in the touch panel, a GUI can be configured as if the user can directly operate screens displayed on the touch panel. An input/output I/F 209 is an interface with the input/output apparatus 210, and transmits input and operations received from users to each processing unit such as the CPU 201. In addition, the input/output I/F 209 outputs image data to be displayed on the display of the input/output apparatus 210.

The device control unit 207 controls the printing unit 208 according to printing requests and the like. The printing unit 208 is an image output device that forms images according to received print jobs and outputs the images to paper, or outputs images that a scanner has optically read to paper. It should be noted that the image forming apparatus 102 may include devices that provide functions of the image forming apparatus 102 such as scanners in addition to the printing unit 208 that provides printing functions.

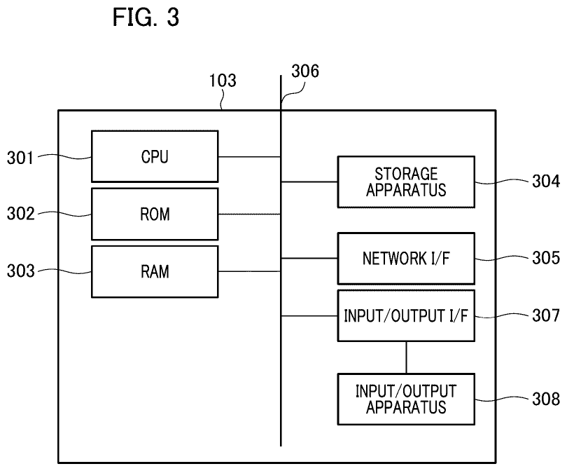

FIG. 3 is a diagram showing a hardware configuration of a user terminal 103 that is a client apparatus. The user terminal 103 comprises a CPU 301, a ROM 302, a RAM 303, a storage apparatus 304, a network I/F 305, and an input/output I/F 307. Each of these units is connected via an internal bus 306. Furthermore, the user terminal 103 comprises an input/output apparatus 308 that is connected to the input/output I/F 307.

The CPU 301 controls the user terminal 103. The CPU 301 loads programs stored in memory (ROM 302 or storage apparatus 304) to the RAM 303 as necessary and executes the programs, and comprehensively controls each unit connected to the internal bus 306. The ROM 302 stores various programs such as basic control programs of the user terminal 103, and the like. The RAM 303 functions as memory or a work area of the CPU 301. The storage apparatus 304 stores various data such as application programs, image data, and the like.

The input/output apparatus 308 is an operation unit that is configured by a keyboard, a mouse, a liquid crystal display, a touch panel, and the like, and connects to the CPU 301 via the input/output I/F 307. The user terminal 103 performs communication via the network I/F 305 with external network equipment such as the image forming apparatus 102, and the like. The network I/F 305 performs communication via the network 101 with external network equipment.

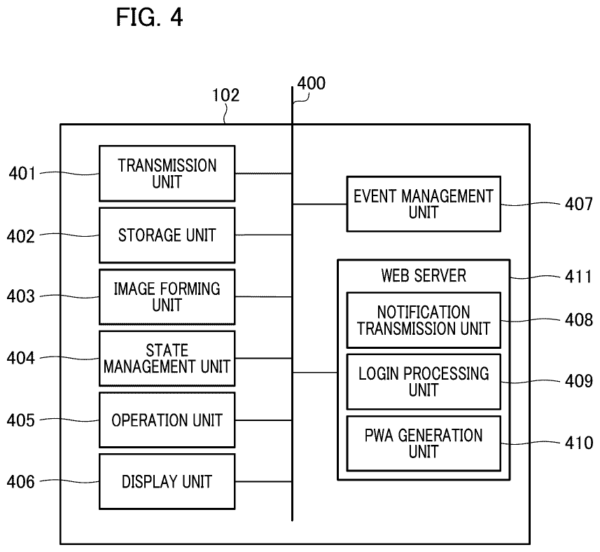

FIG. 4 is a diagram showing a software configuration of an image forming apparatus 102 that is a network device. The image forming apparatus 102 comprises a transmission unit 401, a storage unit 402, an image forming unit 403, a state management unit 404, an operation unit 405, a display unit 406, an event management unit 407, a web server 411, a notification transmission unit 408, a login processing unit 409, and a PWA generation unit 410. These software modules are connected to each other via a device interface 400.

The transmission unit 401 transmits data processed in the image forming apparatus 102 externally via a network. For example, the transmission unit 401 first acquires device information of the image forming apparatus 102, event information generated in the image forming apparatus 102, various counter information, consumption information of consumable parts, and the like from the storage apparatus 204. The transmission unit 401 edits the acquired information into a format for transmitting the acquired information to the push server 104, and transmits the acquired information to the push server 104 for the purpose of notifying the acquired information to the user terminal 103 of a user by push notification. In addition, the transmission unit 401 receives data from external devices via the network. For example, the transmission unit 401 also receives print data from the user terminal 103. Protocols such as SMTP, HTTP/HTTPS, SNMP, FTP, SMB, and the like are used for data transmission and reception. It should be noted that the device information includes identification information (serial number) of the image forming apparatus 102, network information (for example, IP address), operation information, and the like, and any of this information is used for notification and the like as necessary.

The storage unit 402 performs storage control such as storage of information to and reading of information from the ROM 202, the RAM 203, and the storage apparatus 204. In addition, the storage unit 402 stores management information necessary for management of the image forming apparatus 102. For example, the storage unit 402 stores firmware information, device information such as identification numbers of the image forming apparatus 102, network setting information, various counter information, consumption information of consumable parts, operation history of the image forming apparatus 102, and history information (log data) that represents abnormal states, and the like. In addition, information related to the user terminal 103, user information, information related to the push server 104, and the like are stored in the storage unit 402. The user information includes information of authority of users.

The image forming unit 403 has a function of generating and outputting print data to be passed to the printing unit 208. The state management unit 404 performs print control and management of abnormal states of the image forming apparatus 102, and also performs management of counter information and management of notification information. As counter information, for example, the state management unit 404 stores and manages values counted by sensors and the like of the number of printed sheets printed by the image forming apparatus 102, and consumption information indicating consumption levels of parts or remaining amounts of consumables such as toner bottles in the storage unit 402.

The operation unit 405 is an interface that enables operation instructions with respect to the image forming apparatus 102 including print instructions from users. The display unit 406 performs control of display of UI screens such as state information of the image forming apparatus 102, information of consumption rates of various consumables (including toner remaining amount information), setting information, and function buttons to users.

The event management unit 407 manages event information by receiving events that occur in the image forming apparatus 102. Event information managed by the event management unit 407 includes print job events that users of the image forming apparatus 102 issue, errors (failures), general status information of the image forming apparatus 102, and the like. For example, errors of the image forming apparatus 102 include highly urgent errors such as hard disk errors, and warning level errors such as paper jams or toner low, and the like. In addition, event information representing replacement of toner bottles, firmware updates, and the like are similarly notified to the event management unit 407 via the device interface 400. In addition, the event management unit 407 also performs issuance processing of push notification requests to the notification transmission unit 408 by detecting occurrence of events.

The web server 411 functions as a providing unit for the image forming apparatus 102 to provide a website. Acting as a web server, the web server 411 provides the RUI of the image forming apparatus 102 and a website for providing a PWA having RUI functions. In addition, the web server 411 also performs processing related to progressive web apps (PWAs) that provide RUI functions provided via websites. The web server 411 comprises the notification transmission unit 408, the login processing unit 409, and the PWA generation unit 410.

The notification transmission unit 408 is realized as a function of an application server implemented in the image forming apparatus 102. The notification transmission unit 408 receives requests from the event management unit 407, and issues data for push notifications to user terminals 103 of notification targets that are registered in advance. When the notification transmission unit 408 receives push notification requests from the event management unit 407, the notification transmission unit 408 edits data related to notification content into a predetermined format for making requests to the push server 104, and transmits the data to the push server 104. The notification content includes, for example, device information of the image forming apparatus 102 stored in the storage apparatus 204, event information generated in the image forming apparatus 102, various counter information, consumption information of consumable parts, and the like.

The login processing unit 409 performs user authentication. The login processing unit 409 performs, for example, authentication processing that is executed when a user acquires information of the image forming apparatus 102 by logging in to the RUI by using the user terminal 103, or when the user performs setting changes. In addition, the login processing unit 409 performs user authentication in response to user authentication requests from PWAs installed on the user terminal 103, and responds authentication results to the PWAs. Authentication processing is performed based on, for example, user authentication information received from users and user information stored in the storage unit 402. User authentication information is, for example, combinations of user names and passwords that users input, information stored in IC cards, biometric information, and the like, and methods of authentication processing are not limited. The PWA generation unit 410 has a function of generating PWAs that provide RUI functions according to user information when the user terminal 103 accesses the RUI.

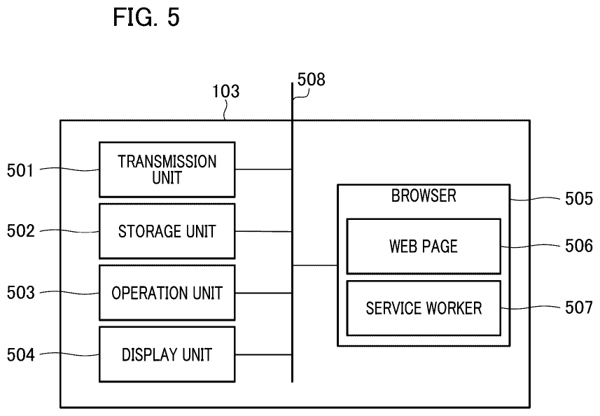

FIG. 5 is a diagram showing a software configuration of a user terminal 103 that is a client apparatus. The user terminal 103 comprises a transmission unit 501, a storage unit 502, an operation unit 503, a display unit 504, a browser 505, a web page 506, and Service Worker 507. These are connected to each other via an internal bus 508. It should be noted that FIG. 5 shows a software configuration before a PWA is installed, and after installation of the PWA to the terminal 103, the PWA is added thereto.

The transmission unit 501 transmits data processed in the user terminal 103 to external devices via a network. For example, the transmission unit 501 transmits user authentication information such as user ID and password input from users via the operation unit 503 to the image forming apparatus 102. The storage unit 502 performs storage control such as storage and reading of information to the ROM 302, the RAM 303, and the storage apparatus 304 of the user terminal 103. The operation unit 503 is an interface that enables operation instructions to the user terminal 103 by users. The display unit 504 performs control of display to screens such as converting and transmitting screen data for display on the input/output apparatus 308 of the user terminal 103.

The user terminal 103 displays websites (web pages) provided by the image forming apparatus 102 via the browser 505. In the present embodiment, websites provided by the image forming apparatus 102 are the RUI that the image forming apparatus 102 provides. In addition, the user terminal 103 downloads, via the RUI displayed on the browser 505, a PWA for device management having one or more functions that the image forming apparatus 102 provides by using a main body screen or the RUI. The browser 505 has functions of the web page 506 that is a website and functions of Service Worker 507.

The web page 506 is an RUI provided by the image forming apparatus 102. Service Worker 507 is a program (JavaScript) that defines behaviors of the PWA such as background operation, cache control, push notifications, and icon display on home screens. Operations by Service Worker 507 are executed in the background separately from the website provided in the browser 505. That is, push notifications and the like to installed PWAs are realized via Service Worker 507 operating in the background even when the browser 505 is not connected to the RUI. When a user installs a PWA from the image forming apparatus 102 via the RUI, the browser 505 downloads Service Worker 507 from the image forming apparatus 102 via the RUI and registers Service Worker 507 to the browser 505 as part of the PWA.

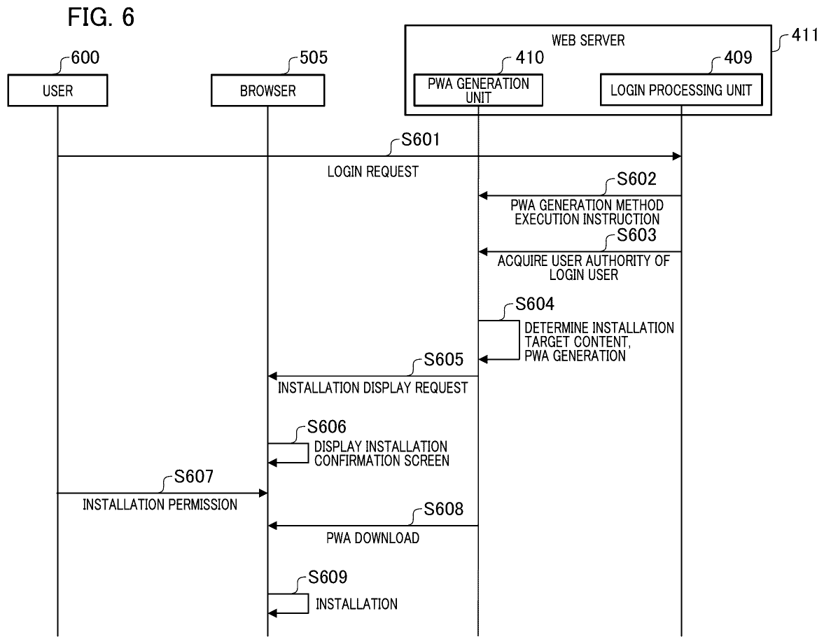

FIG. 6 is a sequence diagram explaining PWA installation processing executed in the management system. The PWA installation processing is processing that provides a website for installing a PWA to the user terminal 103 by generating the PWA, and causes the PWA to be installed to the browser 505 of the user terminal 103. In the present embodiment, a PWA is generated by determining functions to be provided by the PWA according to user authority of a user who accessed the RUI (website), and the PWA is provided to the user terminal 103. Each processing executed by the image forming apparatus 102 shown in FIG. 6 is realized by the CPU 201 of the image forming apparatus 102 executing programs by calling the programs from memory. Each processing executed by the user terminal 103 shown in FIG. 6 is realized by the CPU 301 of the user terminal 103 executing programs by calling the programs from memory.

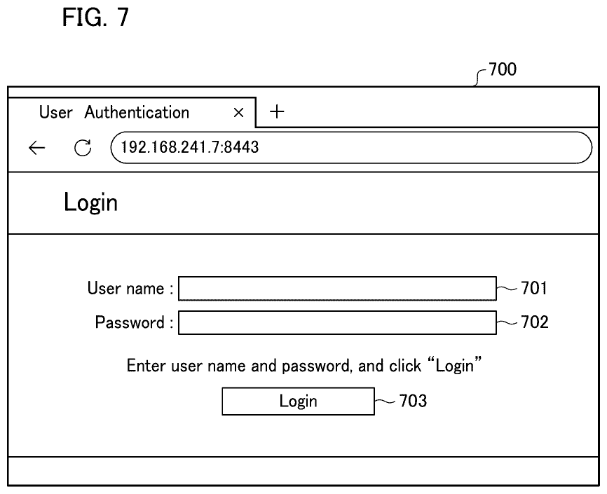

In step S601, the browser 505 of the user terminal 103 accesses the RUI of a website that the image forming apparatus 102 provides based on operations from a user, and performs a login request to the image forming apparatus 102. This processing is processing in which the user 600 logs in to the RUI that the image forming apparatus 102 provides by using the user terminal 103. The login request is transmitted to the web server 411 of the image forming apparatus 102 by the user 600 inputting user authentication information and pressing a login button on a login screen displayed on the browser 505 of the user terminal 103. An example of the login screen is shown in FIG. 7. FIG. 7 is a diagram showing an example of a login screen for the RUI displayed on the browser 505. The login screen 700 is displayed, for example, when the user 600 accesses the RUI of the image forming apparatus 102 by using the user terminal 103. The login screen 700 displays an input area for inputting a combination of a user name 701 and a password 702 as user authentication information, and a login button 703. It should be noted that the user authentication information may be a user ID, email address, telephone number, biometric information, IC card information, and the like. The login request is transmitted from the user terminal 103 to the web server 411 of the image forming apparatus 102 by the user 600 inputting user authentication information and clicking the login button 703.

The login processing unit 409 of the web server 411 of the image forming apparatus 102 receives the login request from the browser 505 of the user terminal 103. The login processing unit 409 performs login processing by using user authentication information received from the user 600. The user authentication information is, for example, a combination of a user name and a password. The login processing unit 409 collates the user authentication information received from the user 600 against user information registered in advance. User information such as user names and passwords registered in advance may be stored in the storage unit 402 (ROM 202 or storage apparatus 204) within the image forming apparatus 102, or in a terminal or server external to the image apparatus. In a case in which the login processing unit 409 succeeds in authentication of the user 600, processing of step S602 is performed.

In step S602, the login processing unit 409 of the web server 411 of the image forming apparatus 102 performs a PWA generation method execution instruction to the PWA generation unit 410 of the web server 411. The PWA generation method execution instruction is an instruction for execution of generation processing of a device management PWA to be installed on the user terminal 103. In step S603, the login processing unit 409 of the web server 411 of the image forming apparatus 102 transmits authority information of the user 600 who is a login user to the PWA generation unit 410. Login user authority information may be stored in the storage unit 402 (ROM 202 or storage apparatus 204) within the image forming apparatus 102, or in a terminal or server external to the image apparatus. Accordingly, in S602 and S603, the PWA generation unit 410 of the web server 411 acquires the PWA generation method execution instruction and information of user authority corresponding to the login user used when generating the PWA.

In step S604, the PWA generation unit 410 of the web server 411 of the image forming apparatus 102 determines functions of the PWA to be generated according to authority of the login user, and generates software as a PWA. In the present embodiment, the PWA generation unit 410 determines functions available in the Progressive Web App according to whether the login user has administrator authority or authority different from administrator authority (general user authority). In a case in which authority of the login user is an administrative user, the PWA generation unit 410 determines only functions (content) predetermined to be provided to administrative users as functions to be provided as a PWA. In contrast, in a case in which authority of the login user is authority different from that of an administrative user, the PWA generation unit 410 determines only content predetermined to be provided to general users as functions to be provided as a PWA. The PWA generation unit 410 generates a PWA that provides the determined functions.

The device management PWA provides event information generated in the image forming apparatus 102, various counter information, consumption information of consumable parts, various logs, errors, and the like. In addition, the device management PWA provides functions for changing device information of the image forming apparatus 102, network settings, user settings, user terminal 103 information, and the like. For example, among the functions that the device management PWA provides, it is not preferable that general users who use the image forming apparatus 102 be able to handle the network setting change function. Accordingly, the network setting change function is predetermined to be provided only to a PWA for administrative users and not to be provided to a PWA for general users. The PWA generation unit 410 determines whether or not to include the network setting change function in the device management PWA based on the authority information of the user 600 received from the login processing unit 409.

Functions provided only to administrative users may include some or all of the functions for changing device settings of the image forming apparatus 102, security settings, user settings, and information related to the user terminal 103, in addition to network setting changes. In addition, functions provided only to administrative users may include some or all of the information providing functions such as event information generated in the image forming apparatus 102, various counter information, consumption information of consumable parts, various logs, and errors. General users must not be able to handle functions for administrative users (functions that only administrative users can handle). In contrast, administrative users may handle only functions for administrative users, or may be able to handle functions for general users as well. Functions provided to both general users and administrative users may exist. Whether each function is provided for administrative users or for general users is predetermined.

In step S605, the PWA generation unit 410 of the web server 411 of the image forming apparatus 102 requests the browser 505 of the user terminal 103 that the user 600 is using to install the generated PWA. That is, the PWA generation unit 410 provides a website in order to enable the generated PWA to be provided to the browser 505 of the user terminal 103 that transmitted the login request.

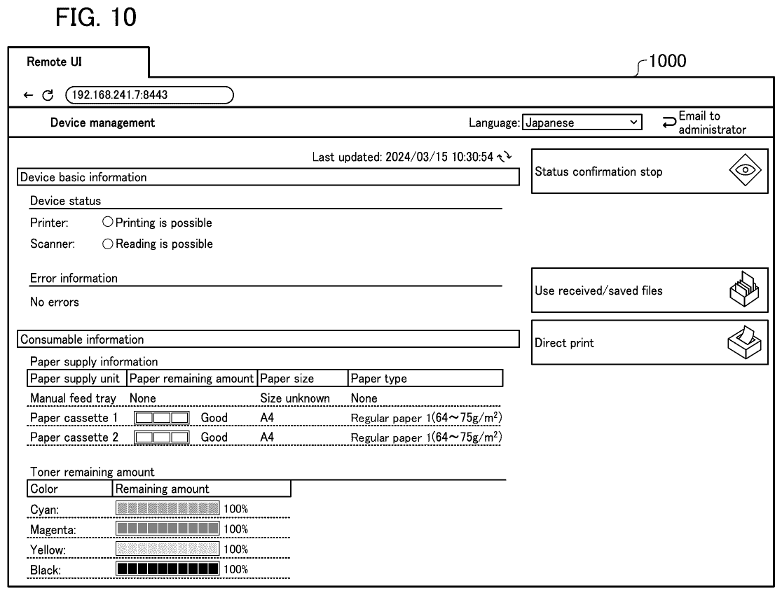

In step S606, the browser 505 displays an installation confirmation screen for confirming installation permission from the user based on the PWA installation request received from the web server 411 of the image forming apparatus 102. In the installation confirmation screen, for example, “Allow” and “Reject” buttons for whether or not to install the PWA are displayed so as to be selectable by the user 600. In step S607, the user 600 selects whether or not to permit installation of the PWA. In a case in which the user 600 rejects installation of the PWA (in a case in which installation is not permitted), a normal RUI that is not a PWA is provided from the image forming apparatus 102 as page data such as HTML and is displayed on the browser 505. An example of the normal RUI will be described later by using FIG. 10. Hereinafter, a case in which the user 600 permits installation of the PWA will be explained. When the user 600 selects a button for permitting installation of the PWA on the installation confirmation screen, the web server 411 detects that installation of the PWA has been permitted by the user 600.

In step S608, the PWA generation unit 410 of the web server 411 of the image forming apparatus 102 provides the generated software as a PWA by causing the software to be downloaded to the browser 505 within the user terminal 103 that the user 600 uses. After download of the PWA is completed, processing of step S609 is performed. In step S609, the browser 505 of the user terminal 103 installs the PWA downloaded from the web server 411 of the image forming apparatus 102. After installing the PWA, an icon is generated on the desktop, home screen, and the like of the user terminal 103 similar to native apps.

By the above-described processing, in a case in which authority of the login user is an administrative user, the image forming apparatus 102 provides content (functions) predetermined to be provided to administrative users as a device management PWA. In contrast, in a case in which authority of the login user is authority different from that of an administrative user, the image forming apparatus 102 provides only content (functions) predetermined to be provided to general users as a device management PWA. The image forming apparatus 102 provides the RUI (website) via the web server 411 so that the image forming apparatus 102 can provide to the user terminal 103 a PWA having functions that differ according to the authority of a user who has logged in to the RUI (website).

It should be noted that although the present embodiment explained an example in which the PWA generation unit 410 determines functions that the PWA provides according to user authority and generates the PWA in step S604, the PWA generation unit 410 is not limited thereto. For example, the PWA generation unit 410 may determine functions that the PWA provides according to user authority in step S604, and in a case in which installation permission is obtained from the user, the PWA generation unit 410 may provide a PWA by generating the PWA according to the determined functions.

In addition, although the present embodiment explained based on a premise that a PWA is provided for general users having authority different from administrator authority, whether or not to provide a PWA for general users can be set by an administrative user. A user having administrator authority can perform settings for whether or not to permit installation of a PWA for authority different from administrator authority (general users) on a setting screen provided by the web server 411 different from the website of the RUI. In step S604, the web server 411 confirms authority of the user, and in a case in which the confirmed user authority is a general user, the web server 411 confirms settings for whether or not to permit installation of a PWA for general users, and generates a PWA for general users in a case in which installation is permitted.

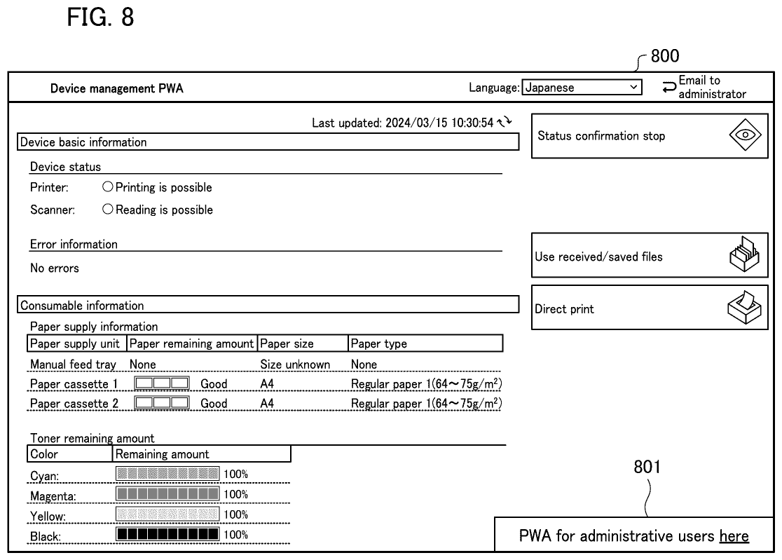

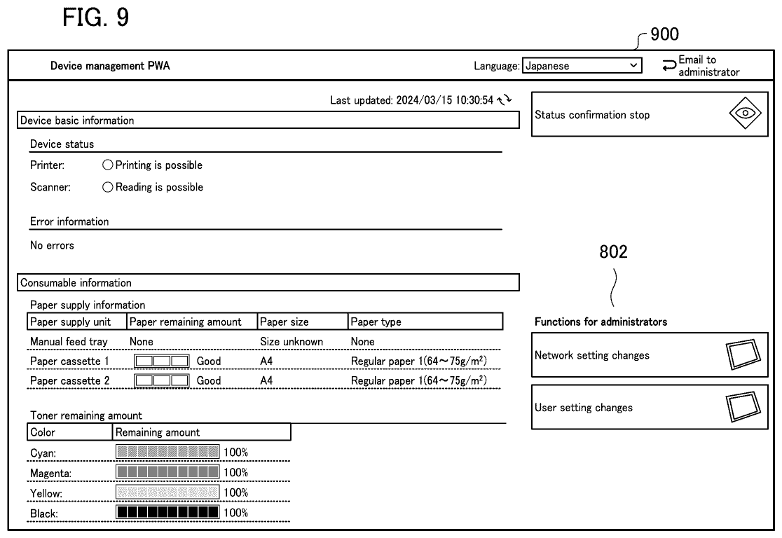

Next, examples of screens of the device management PWA displayed on the user terminal 103 will be explained for each user authority by using FIG. 8 and FIG. 9. FIG. 8 is a diagram showing an example of a PWA screen for general users having authority different from administrator authority. A PWA screen 800 is a screen that a PWA providing RUI functions displays, wherein the PWA is installed in step S609 when a general user logs in. On the PWA screen 800, general users can view event information generated in the image forming apparatus 102, various counter information, consumption information of consumable parts, various logs, and error information. In addition, the PWA for general users is also provided with functions for changing some device settings of the image forming apparatus 102 that can be configured even by general users. In contrast, functions for changing device settings such as network setting changes that can be configured only by users having administrator authority are not provided in the PWA for general users.

In addition, the PWA for general users may be provided with text, links, and push notifications indicating that a PWA for administrative users can also be installed. An administrative user link 801 is a display example of text indicating that installation of a PWA for administrative users is also possible and a link to a login screen that are displayed on the PWA for general users. Content similar to the administrative user link 801 may be notified by push notification. When the administrative user link 801 is selected, the web server 411 provides the login screen 700 shown in FIG. 7 to the browser 505. The web server 411 performs user authentication based on user authentication information acquired from the login screen 700, and in a case in which a user whose login was permitted is a user having administrator authority, the web server 411 generates a PWA for administrators, and provides the PWA. By performing user authentication by using user authentication information of a user having administrator authority, download and installation of a PWA for administrative users can also be performed.

FIG. 9 is a diagram showing an example of a screen of a PWA for administrative users having administrator authority. A PWA screen 900 is a screen that a PWA providing RUI functions displays, wherein the PWA is installed in step S609 when an administrative user logs in. In the PWA for administrators, in addition to RUI functions for general users, network setting changes, user setting change functions, and the like are provided as functions for administrators 802.

In addition, functions provided to administrative users may include some or all of information providing functions such as event information generated in the image forming apparatus 102, various counter information, consumption information of consumable parts, various logs, errors, and the like. Furthermore, functions provided to administrative users may include some or all of functions for changing device settings of the image forming apparatus 102, information related to the user terminal 103, and the like. Some of the functions provided to administrative users are not provided to general users, and are provided only to administrative users.

FIG. 10 is a diagram showing an example of a standard RUI that the image forming apparatus 102 provides. The RUI 1000 is a RUI screen that is not a PWA and that is displayed on the browser 505 in a case in which page data such as HTML is provided from the image forming apparatus 102. In a case in which a user did not provide installation permission of a PWA in step S607, a normal RUI that is not a PWA is provided from the image forming apparatus 102. Even in a case in which a user does not permit installation of a PWA and installation of a PWA was not performed, the user can use the RUI 1000. The RUI 1000 is an example of RUI provided to general users having authority different from administrator authority, and functions provided to the RUI 1000 are similar to functions provided to the PWA screen 800 except for the administrative user link 801. In addition, functions of normal RUI provided in a case in which a login user is a user having administrator authority are similar to functions provided in the PWA screen 900 for administrators.

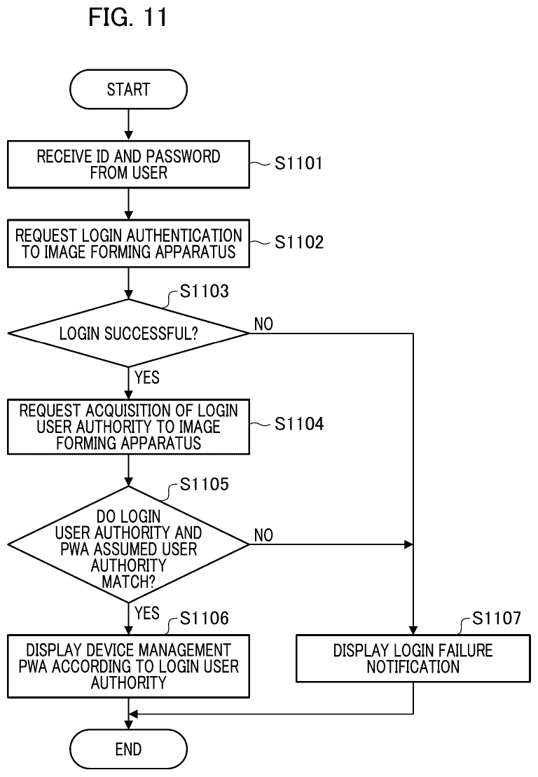

FIG. 11 is a flowchart showing login processing that a PWA performs. The PWA is a PWA that was created according to user authority. Therefore, in login processing, the PWA determines whether a user attempting to log in is a user having user authority that the PWA targets. Each processing executed by the user terminal 103 that installed the PWA shown in FIG. 11 is realized by the CPU 301 of the user terminal 103 executing programs by calling the programs from memory.

This processing is started when a user attempts to log in to a PWA that was created according to user authority and installed on the user terminal 103. In step S1101, the PWA of the user terminal 103 receives user authentication information from the user via the browser 505. The user authentication information is, for example, a combination of user name and password. In step S1102, the PWA requests user authentication (login authentication) of a user attempting to log in to the image forming apparatus 102. When requesting user authentication, the PWA transmits user authentication information acquired in step S1101 to the image forming apparatus 102. The image forming apparatus 102 performs user authentication in response to a request of login authentication received from the PWA of the user terminal 103, and responds to the user terminal 103 with authentication results. In step S1103, the PWA determines whether or not login authentication received from the image forming apparatus 102 was successful. In a case in which login authentication was successful, the PWA performs processing of step S1104. In contrast, in a case in which login authentication was not successful, the PWA performs processing of step S1107.

In step S1104, the PWA requests acquisition of user authority that the login user has from the image forming apparatus 102. The image forming apparatus 102 responds to the user terminal 103 with user authority that the login user has in response to an acquisition request of user authority received from the PWA of the user terminal 103. In step S1105, the PWA collates whether user authority of the login user received from the image forming apparatus 102 matches user authority that the PWA supports. In a case in which user authority of the login user and user authority that the PWA supports match, the PWA determines that collation was successful and performs the processing of step S1106. In contrast, in a case in which the user authority of the login user and user authority that the PWA supports do not match, the PWA determines that collation was not successful and performs processing of step S1107. In the present embodiment, administrator authority and authority different from administrator authority are set as user authorities. For example, in a case in which user authority of the login user is authority different from administrator authority (for example, authority of a general user) and user authority that the PWA supports is administrator authority, user authority does not match, and collation fails. Similarly, for example, in a case in which user authority of the login user is administrator authority and user authority that the PWA supports is authority different from administrator authority, user authority does not match, and collation fails. In contrast, in a case in which user authority of the login user is administrator authority and user authority that the PWA supports is administrator authority, user authority matches, and collation succeeds.

In step S1106, the PWA displays the PWA that was generated according to login user authority and installed on the user terminal 103. In step S1107, the PWA displays a login failure notification on the user terminal 103. That is, the PWA displays notification of login failure in a case in which user authentication failed or in a case in which authority of the login user and user authority that the PWA supports did not match. It should be noted that display of login failure notification displayed in step S1107 may differ between a case in which user authentication processing of step S1103 failed and a case in which collation of user authority of step S1105 failed.

Although in the present embodiment an example was explained in which login to a PWA is possible only in a case in which user authority of the login user matches user authority that corresponds to the PWA, a PWA corresponding to administrator authority is not limited thereto. A PWA corresponding to administrator authority may be capable of providing the RUI of a PWA for general users in a case in which login is accepted using general user authority. A PWA corresponding to administrator authority can provide the RUI of a PWA for administrative users and the RUI of a PWA for general users according to the authority of the login user. Accordingly, in order to enable an administrative user to confirm functions of general users, this enables an administrative user to log in to a PWA for general users (users who do not have administrator authority). Therefore, in a PWA for administrators, rather than determining a match of user authority in the collation between the user authority of the login user and the user authority that the PWA supports in step S1105, the PWA determines the RUI of the PWA to be provided according to the user authority of the login user. Specifically, in a case in which the user authority of the login user is administrator authority, the PWA for administrators determines to display the RUI of the PWA for administrators and performs the processing of step S1106. In contrast, in a case in which the user authority of the login user is authority different from administrator authority, the PWA for administrators determines to display the RUI of the PWA for general users and performs the processing of step S1106. Accordingly, administrative users become capable of using a PWA for general users and confirming functions of the PWA for general users. In a case in which an administrator having administrator authority logs in to a PWA using general user authority, only functions of the device management PWA for general users are provided, and functions of the device management PWA for administrative users are not provided.

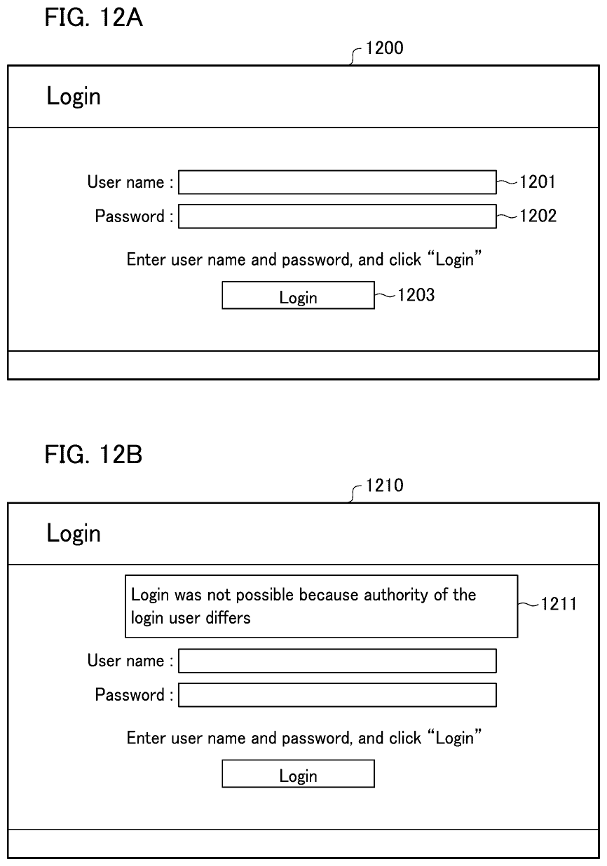

FIG. 12A and FIG. 12B are diagrams showing examples of login screens displayed in PWA login processing. FIG. 12A is an example of a login screen of a PWA. A login screen 1200 is displayed when opening a PWA that was created according to user authority and installed on the user terminal 103. The login screen 1200 displays an input area for inputting a combination of a user name 1201 and a password 1202 as user authentication information, and a login button 1203. It should be noted that the user authentication information may be a user ID, email address, telephone number, biometric information, IC card information, and the like. When the user terminal 103 detects that a user has input user authentication information and clicked the login button 1203, the user terminal 103 executes processing (step S1101) of transmitting a request of login authentication to the web server 411 of the image forming apparatus 102.

FIG. 12B is an example of login failure notification on a login screen. A login failure notification 1211 is an example of a message indicating that authority of a user corresponding to user authentication information and authority of a user that the PWA supports differ. The login failure notification 1211 is displayed on a login screen 1210 in step S1107 in a case in which authority of a user does not match in login processing to a PWA (No in step S1105). It should be noted that, in a case in which user authentication fails (No in step S1103), a login failure notification message different from login failure notification 1211 is displayed. For a message of login failure notification in a case in which user authentication failed, for example, a message indicating that input user authentication information is not correct is displayed.

As explained above, according to the present embodiment, when providing a web page of the RUI as a PWA, the image forming apparatus 102 can provide a PWA to a terminal of a user by dynamically determining functions of the RUI according to authority of a user to be used. Therefore, a PWA according to authority of the user is installed on the terminal of the user, and a user having administrator authority can use functions and content for administrator authority in the PWA. In contrast, for general users having authority different from administrator authority, functions and content for administrators can be made unavailable in the PWA. Accordingly, general users who do not have administrator authority can be prevented from viewing some or all of information related to the image forming apparatus 102 or the user terminal connected to the image forming apparatus 102. In addition, general users who do not have administrator authority can be prevented from performing some or all of setting changes of the image forming apparatus 102.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-154349, filed Sep. 6, 2024, which is hereby incorporated by reference wherein in its entirety.

What is claimed is:

1. A network device that is available through login by a plurality of users having different authorities and that includes a web server comprising:
a memory storing instructions; and
a processor executing the instructions causing the network device to:
provide a website for installing software as a Progressive Web App (PWA) for providing at least part of the functions of the network device to a user terminal via the web server,
wherein the web server provides the website such that a Progressive Web App (PWA) having different available functions can be provided according to authority of a user who has logged into the website.

2. The network device according to claim 1, wherein the web server determines functions available in the Progressive Web App (PWA) according to whether the authority of the user is administrator authority or authority different from administrator authority, and generates a Progressive Web App (PWA) to be provided to the user terminal.

3. The network device according to claim 1, wherein a setting for whether or not to permit installation of a Progressive Web App (PWA) for an authority different from administrator authority can be performed through setting by a user having administrator authority on a setting screen that is provided by the web server and that is different from the website.

4. The network device according to claim 1, wherein the Progressive Web App (PWA) installed on the user terminal confirms authority of a user logging in to the Progressive Web App (PWA), and displays a login failure notification in a case in which the authority does not match authority supported by the Progressive Web App (PWA).

5. The network device according to claim 1, wherein the Progressive Web App (PWA) corresponding to administrator authority installed on the user terminal provides a remote UI of a Progressive Web App (PWA) corresponding to a user having authority different from administrator authority in a case in which a user logs in using authority different from administrator authority.

6. The network device according to claim 1, wherein in a case in which a user logs in to a Progressive Web App (PWA) corresponding to an authority different from administrator authority, a Progressive Web App (PWA) corresponding to administrator authority can be provided via a screen provided by the Progressive Web App (PWA) or via a push notification to the user terminal.

7. The network device according to claim 6, wherein in a case in which the user who received the notification selects a link in the notification, the web server provides a login screen for the website and performs user authentication based on user authentication information acquired from the login screen, and in a case in which the authority of a user permitted to log in is administrator authority, the web server provides the website so that a Progressive Web App (PWA) corresponding to administrator authority can be provided.

8. A control method for a network device that is available through login by a plurality of users having different authorities and that includes a web server, the method comprising:
providing, via the web server, a website for installing software as a Progressive Web App (PWA) for providing at least part of functions of the network device to a user terminal,
wherein the website is provided by the web server so that Progressive Web App (PWA) s having different available functions can be provided according to authority of a user who has logged in to the website.

9. A non-transitory storage medium storing a control program of a network device that is available through login by a plurality of users having different authorities, and that includes a web server causing a computer to perform each step of a control method of the network device, the method comprising:
providing, via the web server, a website for installing software as a Progressive Web App (PWA) for providing at least part of functions of the network device to a user terminal,
wherein the website is provided by the web server so that Progressive Web App (PWA) s having different available functions can be provided according to authority of a user who has logged in to the website.
